(19) United States
(12) Patent Application Publication
(10) Pub. No.: US 2016/0042673 A1
(43) Pub. Date: Feb. 11, 2016

(54) Sign Module with Rigid Faceplate

(71) Applicants: Arnon Z. Wilson, Little Elm, TX (US); Joe Wilson, Plano, TX (US)

(72) Inventors: Arnon Z. Wilson, Little Elm, TX (US); Joe Wilson, Plano, TX (US)

(73) Assignee: PriceVision Inc., Carrollton, TX (US)

(21) Appl. No.: 14/451,433

(22) Filed: Aug. 5, 2014

(51) Int. Cl. G09F 13/06; G09F 13/08; F28F 3/00; G09F 13/04

(52) U.S. Cl. CPC G09F 13/06; G09F 13/0413; G09F 13/08; F28F 3/00; G09F 2013/222

(57) ABSTRACT

A sign module with a rigid faceplate is disclosed. The sign module also includes a printed circuit board having a plurality of light sources attached to the rigid faceplate. The rigid faceplate includes a plurality of transparent regions which are aligned with the plurality of light sources. Fastening mechanisms fasten the printed circuit board and the rigid faceplate. The sign module are attached to a sign face of an electronic sign. Generally the sign face has a decorated region and a display region. The sign module is attached to the display region. The rigid face plate can be colored to match the decorated region to form an electronic sign with a unique appearance.

### BACKGROUND OF THE INVENTION

1. Field of the Invention

The present invention relates to electronic signs.

2. Discussion of Related Art

Electronic signs are commonly used in commercial situations to convey information to customers. For example fuel stations use electronic signs to indicate the price of the fuel to entice customers to use the services of the fuel station. FIG. 1 shows a conventional electronic sign 100. Electronic sign 100 includes a sign face 110 and sign modules 120, 130, 140, and 150. Sign modules 120, 130, 140 and 150 are mounted in an enclosure (not shown) behind sign face 110. The enclosure for electronic sign 100 would also 2 side panels, a back panel, a top panel and a bottom panel. The side panels, top panel, bottom panel, back panel and sign face 110 form the enclosure, which protects the sign modules. In some electronic signs, the enclosure consist typically of aluminum casing in the form of Pan and Lid or a Pan and hinged front cover, which is typically the sign face. For electronic signs that are to be viewed from the front and the back, two electronic signs are typically mounted back to back inside a cabinet. Alternatively, the back panel could also be made into a sign face (similar to sign face 110) and additional sign modules mounted facing the back panel.

As shown in FIG. 1B, sign face 110 includes a decorated region 111 along the edges of sign face 110 and a display region 113 in the middle of sign face 110. Decorated region 111 is typically a single color that matches the branding and marketing colors used by the fuel station. Display region 113 allows the light sources from the sign modules to shine through sign face 110 and be visible to customers. Generally sign face 110 is a large piece of transparent or translucent plastic, such as plexi-glass or acrylic. Decorated region 111 is generally formed by putting decals on the inside face of sign face 110 or by painting sign face 110.

FIG. 1C shows sign module 120, which includes a printed circuit board 121, light sources 123, and various control circuits (not shown) for light sources 123. Light sources 123, which are typically light emitting diodes (LED) (including surface mounted LEDs), are arranged to form a squared off version of the numeral eight. Using two rows/columns of light sources for each segment of the numeral eight. The specific arrangement of the light sources can vary between electronic signs. With the squared off eight arrangement each numerals 0-9 can be formed by turning the appropriate light sources on or off.

Sign Module 150 differs from sign modules 120, 130 and 140 in the arrangement of light sources. Specifically, the light sources of sign module 150 are arranged to from the fraction 9/10 because the fuel industry typically includes 9/10 of a cent in the price of fuel.

The enclosure, including sign face 110 provides protection for the sign modules from many environmental factors such as rain, hail and wind. However, as electronic signs become larger a number of issues can arise. For example, excess heat can become a problem especially with bright light sources and in areas with high ambient temperatures, or in direct sunlight. The excess heat may damage the light sources or the control circuits in the sign modules. In addition, large pieces of plastic (such as sign face 110) have some flexibility which may cause parts of sign face 110 to hit and damage the sign modules. Furthermore, flexing of sign face 110 may be detrimental to the appearance of electronic sign 100. Hence there is a need electronic signs that are more damage resistant than conventional electronic signs.

### SUMMARY

Accordingly, the present invention provides a novel sign module that is more resistant to damage than conventional sign modules. In some embodiments of the present invention the sign module includes a rigid faceplate having a plurality of transparent regions aligned with the light sources on a printed circuit board. The rigid faceplate can act as a heat sink that disperses heat from the light sources or heat from outside the electronic signs. Furthermore, the rigid faceplate can prevent flexing of a sign face which may damage conventional sign modules.

In a specific embodiment of the present invention the sign module includes a printed circuit board having a plurality of light sources attached to a rigid faceplate having a plurality of transparent regions. The transparent regions are aligned with the light sources so that light from the light sources are visible. The sign module is attached to a sign face of an electronic sign. The sign face generally includes a decorated region and one or more display regions. The sign module is attached to the sign face at the display region. Specifically, the rigid faceplate is attached to the sign face. The rigid faceplate minimizes flexing of the sign face and thus protects the printed circuit board and light sources from damage that may be caused by flexing of the sign face.

The present invention will be more fully understood in view of the following description and drawings.

### BRIEF DESCRIPTION OF THE DRAWINGS

FIGS. 1A-1C illustrate a portion of a conventional electronic sign.

FIGS. 2A-2B illustrate a rigid faceplate used in sign modules in accordance with one embodiment of the present invention.

FIG. 3 is an illustration of a sign module in accordance with one embodiment of the present invention.

FIGS. 4A-4B are illustrations of sign modules in accordance with some embodiments of the present invention.

FIG. 5 is an illustration of a sign module in accordance with one embodiment of the present invention.

FIG. 6 is an illustration of an electronic sign in accordance with one embodiment of the present invention.

FIG. 7 is an illustration of an electronic sign in accordance with one embodiment of the present invention.

FIG. 8A-8B is an illustration of electronic sign in accordance with one embodiment of the present invention.

### DETAILED DESCRIPTION

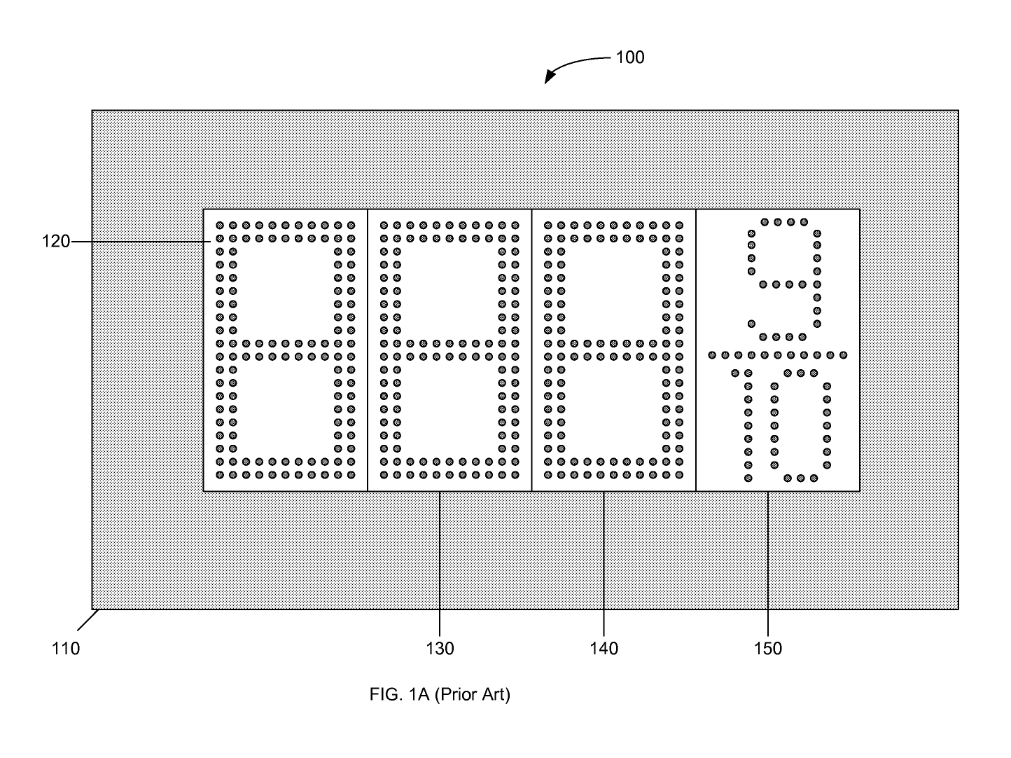

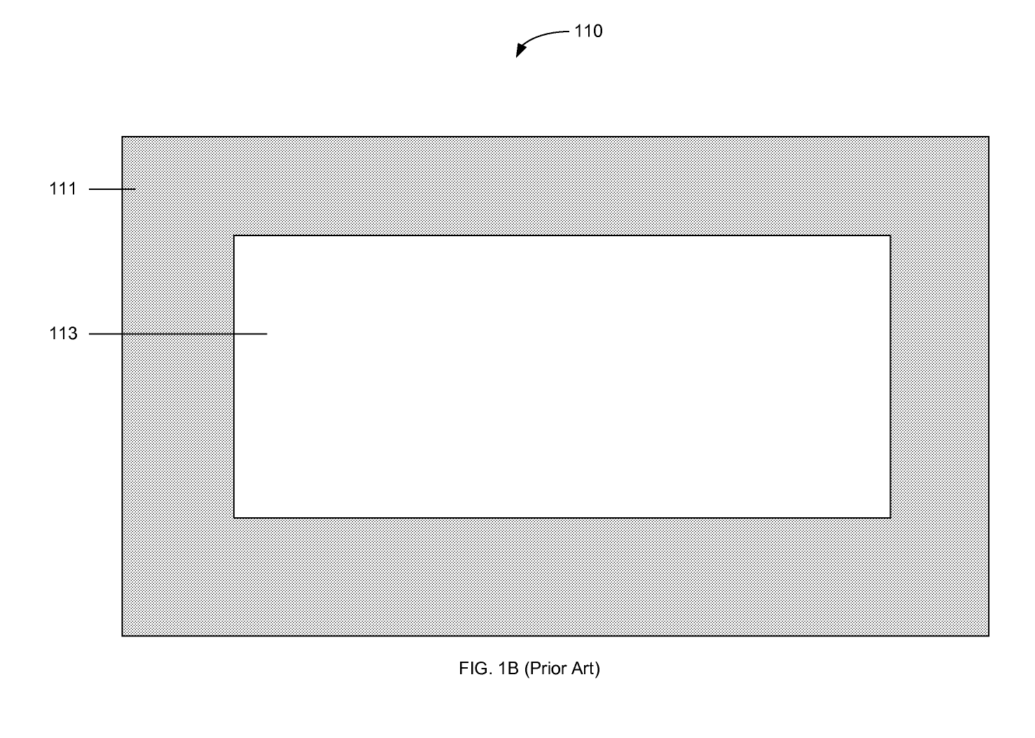

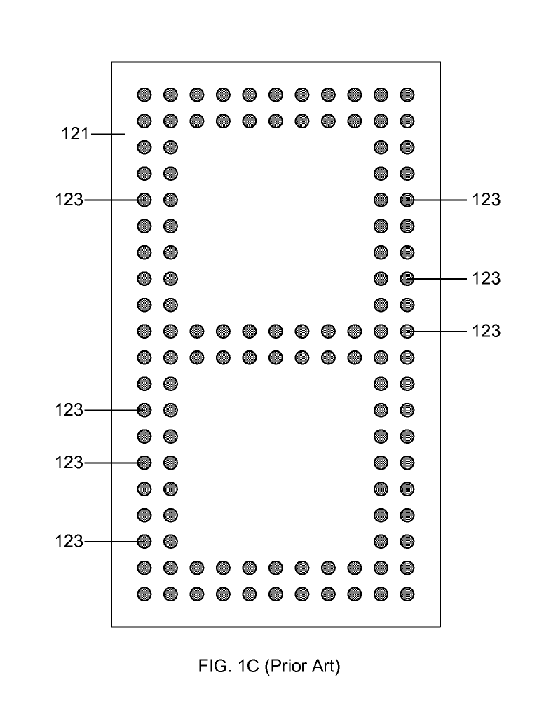

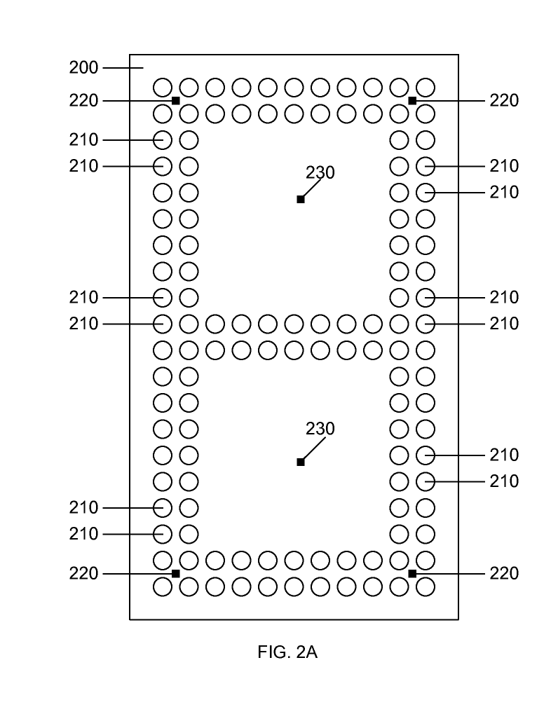

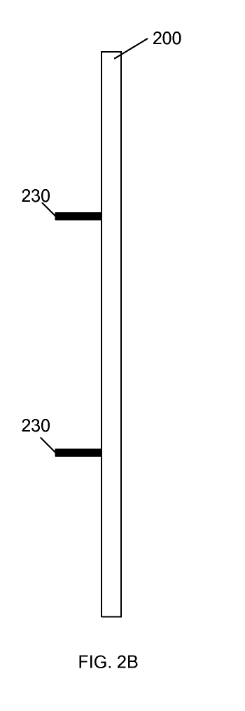

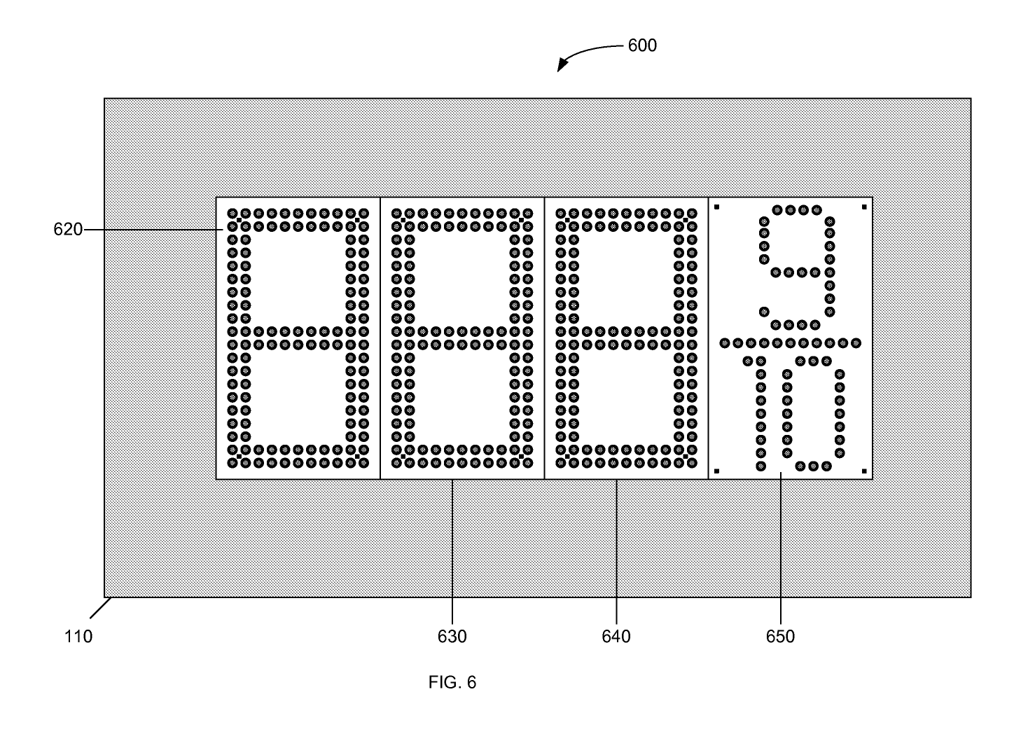

As explained above, the sign modules in conventional electronic signs are susceptible to damage due to flexing of the sign face and excess heat. However sign modules in accordance with embodiments of the present invention are much less susceptible to such damage. FIG. 2A illustrates a rigid faceplate 200 for use with sign modules in accordance with one embodiment of the present invention. Rigid faceplate 200 includes a set of transparent regions 210, a first set of fastening mechanism 220 for attaching to a sign face of an electronic sign, and a second set of fastening mechanisms 230 for attaching rigid faceplate 200 to a printed circuit board having light sources. However, some embodiments of the present invention use a single set of fastening mechanisms to attach the printed circuit board to the rigid faceplate and to the sign face. Rigid faceplate 200 is made with a strong material that can resist flexing of sign face 110. For example, rigid faceplate 200 could be made with aluminum, steel, copper, stronger plastics such as polycarbonate, or wood, or a combination of material. In a particular embodiment of the present invention, rigid faceplate 200 is made of aluminum and has a thickness of approximately 0.04 inches. Transparent regions 210 are aligned with the light sources on the printed circuit board to be used with rigid faceplate 200 (See FIG. 6). In one embodiment of the present invention transparent regions 210 are holes in rigid faceplate 200. In the particular embodiment of FIG. 2A, the transparent regions are arranged to form a squared off version of the numeral eight to match the arrangement of light sources in sign module 120 (See. FIG. 1C).

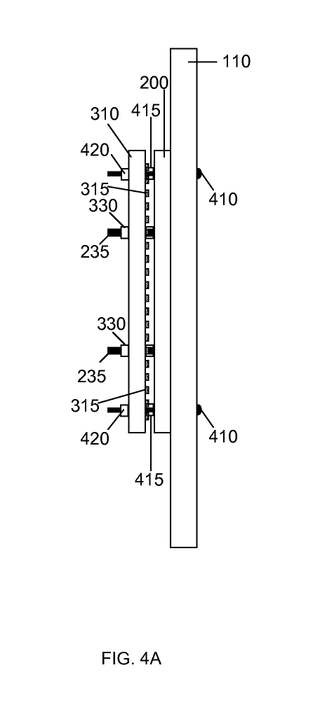

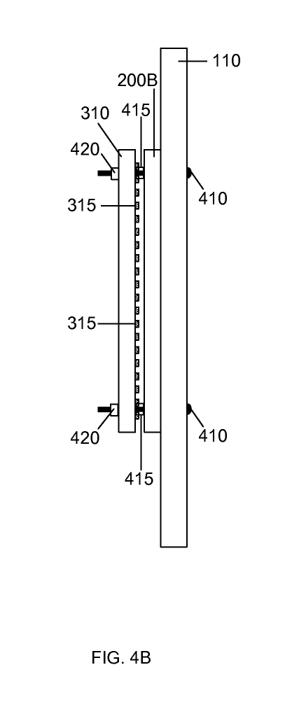

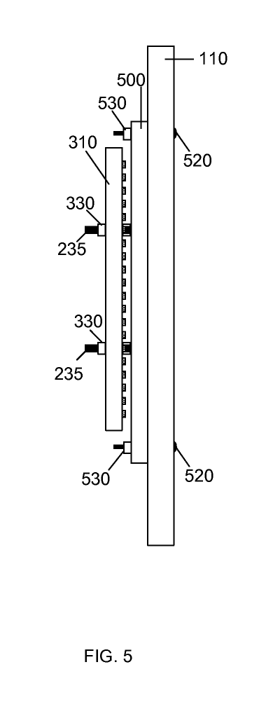

Fastening mechanism 220 are used to attach rigid faceplate 200 to sign face 110. In one embodiment of the present invention fastening mechanism 220 is a hole to allow a screw pass through rigid faceplate 200 so that a nut can be used with the screw to hold rigid faceplate 200 to the sign face of an electronic sign, as illustrated in FIG. 4A, FIG. 4B and/or FIG. 5 and described below. Other embodiments of the present invention use other fastening mechanisms. For example in another embodiment of the present invention, a press nut us placed on the back the rigid faceplate so that a screw can be used with the press nut to hold the rigid faceplate to the sign face. In still other embodiments of the present invention, semi-permanent fastening mechanisms are used such as gluing the rigid faceplate to the sign face. In the embodiment of FIG. 2A, fastening mechanisms 220 are placed within the squared off numeral 8 formed by transparent regions 210. This placement of the fastening mechanism may provide a better aesthetic appearance because the fastening mechanism is less visible than other placements. However in other embodiments of the present invention the fastening mechanism are located in other places (see for example FIG. 5 in which fastening mechanisms 220 are placed above and below the squared off numeral eight formed by transparent regions 210).

Fastening mechanisms 230 are used to attach rigid faceplate 200 to a printed circuit board. In the embodiment of FIG. 2A, two fastening mechanisms 230 are used. The first fastening mechanisms 230 is horizontally centered and vertically about one third of the length of rigid faceplate 200 from the top of rigid faceplate 200. The second fastening mechanism 230 is horizontally centered and vertically about one third of the length of rigid faceplate 200 from the bottom of rigid faceplate 200. Because, the front face of rigid faceplate 200 is attached to sign face fastening mechanisms 230 generally should not have protrusions on the front face of rigid faceplate 200. Thus, in one embodiment of the present invention, fastening mechanisms 230 are threaded bolts attached to the back face of rigid faceplate 200. FIG. 2B is a side view of rigid faceplate 200. In FIG. 2B fastening mechanisms 230, which are shown in black, are threaded bolts attached to the back of rigid faceplate 200. In one embodiment of the present invention, the threaded bolts are welded to the back of rigid faceplate 200. In another embodiment of the present invention, fastening mechanism 230 are recessed holes that can be used with flat head screws.

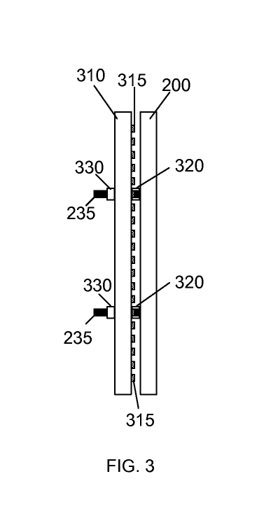

FIG. 3 is a side view of a sign module 300 in accordance with one embodiment of the present invention. Sign module 300 includes rigid faceplate 200 (with fastening mechanisms 230 being more clearly labeled as threaded bolts 235), a printed circuit board 310 having light sources 315, spacers 320, and nuts 330. In FIG. 3, spacers 320 are drawn transparently to better illustrate threaded bolts 235. Printed circuit board 310 is attached to rigid faceplate 200 using threaded bolts 235, spacers 320, and nuts 330. More specifically, threaded bolts 235 pass through spacers 320 and a hole in printed circuit board 310. Nuts 330 are attached to threaded bolts 235 to hold printed circuit board 310 to rigid faceplate 200. In some embodiments of the present invention, nuts 330 are wing nuts, which can be attached and detached by hand without need of tools. Spacer 320 creates a small separation between printed circuit board 310 and rigid faceplate 200.

FIG. 4A shows a side view of sign module 300 (as described in FIG. 3) attached to sign face 110 in accordance with one embodiment of the present invention. Specifically, sign module 300 is attached to sign face 110 using screws 410, spacers 415, and nuts 420. More specifically, screw 410 passes through a hole in sign face 110, a hole in rigid faceplate 200, spacer 415, and a hole in printed circuit board 310. Nuts 420 are attached to screws 410 to hold sign module 300 to sign face 110. Thus in the embodiment of FIG. 4A, rigid faceplate is held against sign face 110. The rigidity of rigid faceplate 200 would generally prevent flexing of sign face 110 in the area in contact with rigid faceplate 200. Thus, sign module 300 is less prone to damage from flexing of sign face 110. Furthermore, if rigid faceplate 200 is made of a material that is a good thermal conductor, such as aluminum, rigid faceplate 200 would dissipate heat generated by light sources 315 and heat coming through sign face 110. Thus, rigid faceplate 200 can also prevent heat damage to printed circuit board 310 and light sources 315. In some embodiments of the present invention spacer 415 is replaced with a press nut or other similar fastening mechanism, such as captive nuts, push nuts, cage nuts, linkage clips, and insert nuts. A press nut would allow rigid faceplate 200 to be held more firmly to sign face 110 while minimizing strain on printed circuit board 310. In some embodiments of the present invention, nuts 330 are wing nuts, which can be attached and detached by hand without need of tools.

In some embodiments of the present invention only one set of fastening mechanisms is used. For example, FIG. 4B shows a side view of sign module 300B attached to sign face 110 in accordance with one embodiment of the present invention. Sign Module 300B, which is similar to sign module 300 of FIG. 3 except that a rigid faceplate 200B is used in place of rigid faceplate 200. Rigid faceplate 200B differs from rigid faceplate 200 because rigid faceplate 200B does not fastening mechanisms 230. Fastening mechanisms 230 can be omitted because printed circuit board 310 is fastened with screw 410, spacer 415, and nut 420 as described below. Specifically, Sign module 300B is attached to sign face 110 using screws 410, spacers 415, and nuts 420. More specifically, screw 410 passes through a hole in sign face 110, a hole in rigid faceplate 200B, spacer 415, and a hole in printed circuit board 310. Nuts 420 are attached to screws 410 to hold sign module 300 to sign face 110. In most embodiments of the present invention that do not include fastening mechanism 230, spacers 415 is replaced with a press nuts.

FIG. 5 shows a side view of a sign module attached to sign face 110 in accordance with another embodiment of the present invention. In the embodiment of FIG. 5 the sign module is very similar to sign module 300 (FIG. 3) thus the description is not repeated and only differences are described in detail. Specifically in the embodiment of FIG. 5 the sign module includes a rigid faceplate 500 that is taller than printed circuit board 310. The sign module is attached to sign face 110 using screws 520, and nuts 530. More specifically, each screw 520 passes through a hole in sign face 110 and a hole in rigid faceplate 500. However, screw 520 does not pass through printed circuit board 310 in the embodiment of FIG. 5. Nuts 530 are attached to screws 520 to hold rigid panel 500 to sign face 110. As in the embodiment if FIG. 4A, the rigidity of rigid faceplate 500 would generally prevent flexing of sign face 110 in the area in contact with rigid faceplate 500.

FIG. 6 shows an electronic sign 600 in accordance with one embodiment of the present invention. Electric sign 600 includes a sign face 110 and sign modules 620, 630, 640, and 650. Sign modules 620, 630, and 640 use the same design as sign module 300 (FIG. 3). Sign module 650 is similar to sign module 300 but the light sources and corresponding transparent regions of the rigid faceplate form the fraction 9/10 rather than the squared numeral eight pattern. Sign modules 620, 630, 640, and 650 are attached to sign face 110 in the manner described above with respect to FIG. 4A or 4B. Although not shown, electronic sign 600 typically would also include 2 side panels, a back panel, a top panel and a bottom panel. The side panels, top panel, bottom panel, back panel and sign face 110 form an enclosure that protects the sign modules. For electronic signs that are to be viewed from the front and the back, the back panel would be similar to sign face 110 and may include additional sign modules attached to the back panel.

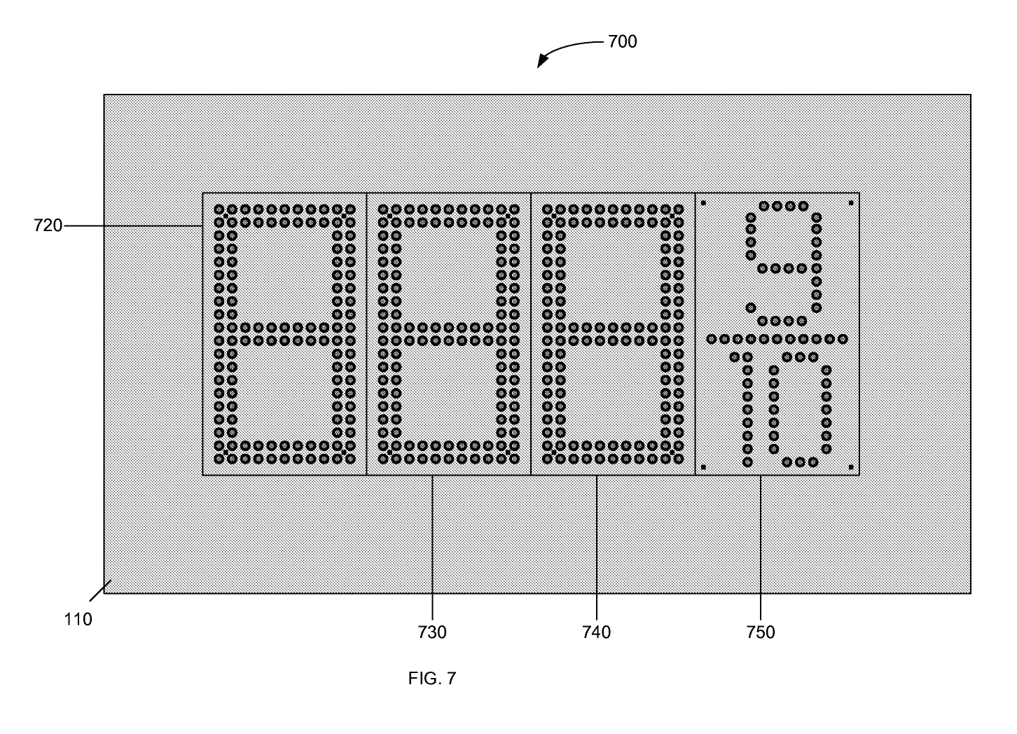

As illustrated in FIG. 6, the rigid faceplates of sign modules 620-650 are visible in the display region of sign face 110. The rigid faceplates have transparent regions that are aligned with the light sources on the printed circuit boards. Thus the light sources are visible through the rigid faceplates and sign face 110. As illustrated in FIG. 7, in some embodiments of the present invention, the appearance of the front of the rigid faceplates are selected to match the decorated region of sign face 110. Specifically, FIG. 7 shows an electric sign 700 with a sign face 110 and sign modules 720, 730, 740, and 750. The rigid face plates of sign modules 720, 730, 740, and 750 are made with aluminum but are painted to match the decorative region of sign face 110. Thus, the appearance of electronic sign 700 is very distinctive as compared to conventional electronic signs and may attract more customers.

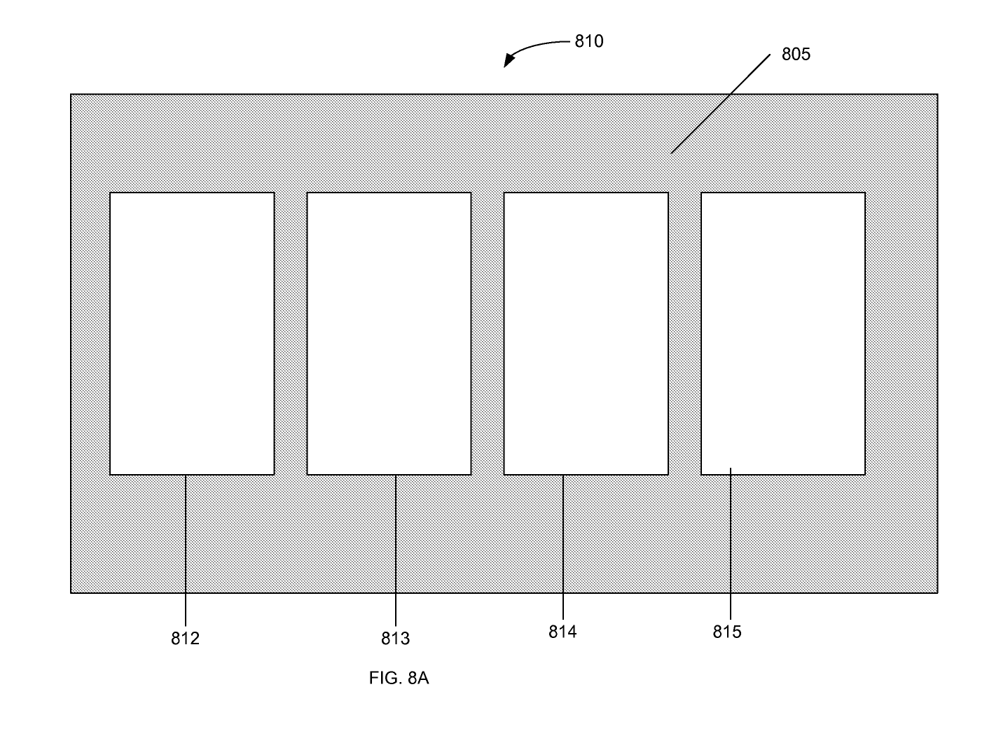

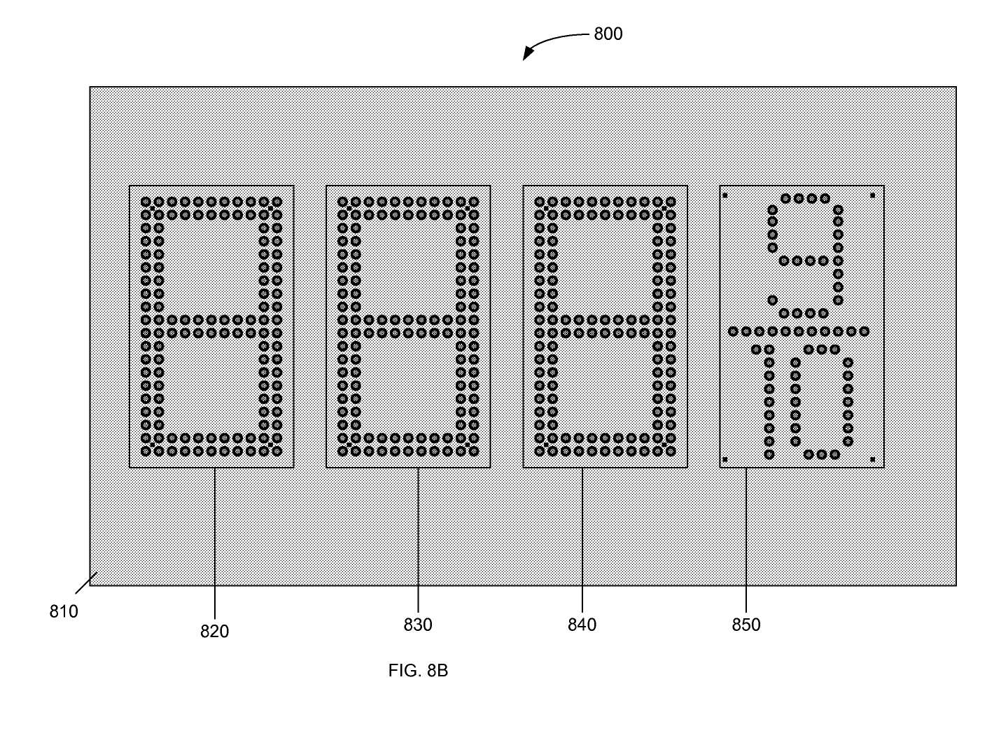

FIG. 8A shows a sign face 810 used with some embodiments of the present invention. Sign face 810 includes a decorated region 805 and four display regions 812, 813, 814, and 815. Specifically, display regions 812, 813, 814, and 815 have a rectangular shape and are separated by portions of decorated region 805. FIG. 8B shows an electric sign 800, which includes sign face 810 and sign modules 820, 830, 840, and 850 in accordance with one embodiment of the present invention. Sign modules 820, 830, and 840 use the same design as sign module 300 (FIG. 3). Sign module 850 is similar to sign module 300 but the light sources and corresponding transparent regions of the rigid faceplate form the fraction 9/10 rather than the squared numeral eight pattern. Sign modules 820, 830, 840, and 850 are attached to sign face 110 in the manner described above with respect to FIG. 4A or 4B. Specifically, sign module 820 is aligned with display region 812, sign module 830 is aligned with display region 813, sign module 840 is aligned with sign module 814, and sign module 850 is aligned with display region 815. Although not shown, electronic sign 800 typically would also include 2 side panels, a back panel, a top panel and a bottom panel. The side panels, top panel, bottom panel, back panel and sign face 810 form an enclosure that protects the sign modules. The rigid faceplates of sign modules 820-850 are visible in the display region of sign face 110. The rigid faceplates have transparent regions that are aligned with the light sources on the printed circuit boards. Thus the light sources are visible through the rigid faceplates and sign face 110. Furthermore, the front of the rigid faceplates painted to match the decorated region of sign face 810. Thus, the appearance of electronic sign 800 is very distinctive as compared to conventional electronic signs and may attract more customers.

In the various embodiments of the present invention, novel structures and methods have been described for creating an electronic sign and sign modules. The various embodiments of the structures and methods of this invention that are described above are illustrative only of the principles of this invention and are not intended to limit the scope of the invention to the particular embodiment described. For example, in view of this disclosure those skilled in the art can define other sign modules, fastening mechanisms, rigid faceplates, printed circuit boards, sign faces, light sources, and so forth, and use these alternative features to create a method or system according to the principles of this invention. Thus, the invention is limited only by the following claims.

1. A sign module comprising:
a printed circuit board having a plurality of light sources;
a rigid faceplate having a plurality of transparent regions;
a first plurality of threaded bolts attached to the back of the rigid faceplate;
a first plurality of nuts attached to the first plurality of threaded bolts, wherein the first plurality of threaded bolts and the first plurality of nuts attach the rigid faceplate to the printed circuit board; and
wherein the transparent regions of the rigid faceplate are aligned with the light sources of the printed circuit board.

2. The sign module of claim 1, wherein the rigid faceplate is made of aluminum.

3. The sign module of claim 2, wherein the transparent regions of the rigid faceplates are holes in the rigid faceplate.

4. The sign module of claim 1, wherein the first plurality of threaded bolts are welded to the back of the rigid faceplate.

5. The sign module of claim 4, claim 1, wherein the first plurality of threaded bolts have no protrusions on the front of the rigid faceplate.

6. The sign module of claim 5, wherein the threaded bolts pass through the printed circuit board.

7. The sign module of claim 1, attached to a sign face having a decorated region and a display region, wherein the sign module is aligned with the display region.

8. The sign module of claim 7, wherein the rigid faceplate is colored to match the decorated region of the sign face.

9. The sign module of claim 7, wherein the rigid faceplate is painted to match the decorated region of the sign face.

10. The sign module of claim 7, further comprising a second plurality of threaded bolts, wherein each of the second plurality of threaded bolt passes through the sign face and the rigid face plate.

11. The sign module of claim 10, further comprising a second plurality of nuts fastened to the second plurality of threaded bolts.

12. The sign module of claim 11, wherein the second plurality of threaded bolts pass through the printed circuit board.

13. The sign module of claim 11, further comprising a plurality of press nuts, wherein the press nuts are attached to the rigid face plate and wherein each press nut is fastened to a threaded from the second plurality of threaded bolts.

14. The sign module of claim 13, wherein the second plurality of threaded bolts pass through the printed circuit board.

15. The sign module of claim 14, further comprising a second plurality of nuts fastened to the second plurality of threaded bolts.

16. An electronic sign comprising
a sign face having a decorated region and a first display region;
a first sign module comprising:
a printed circuit board having a plurality of light sources;
a rigid faceplate having a plurality of transparent regions;
a first plurality of threaded bolts attached to the back of the rigid faceplate;
a first plurality of nuts attached to the first plurality of threaded bolts, wherein the first plurality of threaded bolts and the first plurality of nuts attach the rigid faceplate to the printed circuit board; and
wherein the transparent regions of the rigid faceplate are aligned with the light sources of the printed circuit board;
and wherein the rigid faceplate is attached to the first display region of the sign face.

17. The electronic sign of claim 16, wherein the rigid faceplate of the first sign module is painted to match the decorated region of the sign face.

18. The electronic sign of claim 16, wherein the sign face is made of plastic.

19. The electronic sign of claim 16, wherein the sign face further comprises a second display region.

20. The electronic sign of claim 19, further comprising:
a second sign module comprising:
a printed circuit board having a plurality of light sources;
a rigid faceplate having a plurality of transparent regions;
a first plurality of threaded bolts attached to the back of the rigid faceplate;
a first plurality of nuts attached to the first plurality of threaded bolts, wherein the first plurality of threaded bolts and the first plurality of nuts attach the rigid faceplate to the printed circuit board; and
wherein the transparent regions of the rigid faceplate are aligned with the light sources of the printed circuit board; and wherein the rigid faceplate is attached to the second display region of the sign face.
